(19) United States
(12) Patent Application Publication
(10) Pub. No.: US 2015/0077682 A1
(43) Pub. Date: Mar. 19, 2015

(54) DISPLAY DEVICE AND DISPLAY WALL HAVING ALIGNMENT UNIT, METHOD FOR ASSEMBLING SAME

(71) Applicant: HON HAI PRECISION INDUSTRY CO., LTD., New Taipei (TW)

(72) Inventor: YI HUNG, Tu-Cheng (TW)

(73) Assignee: HON HAI PRECISION INDUSTRY CO., LTD., New Taipei (TW)

(21) Appl. No.: 14/134,067

(22) Filed: Dec. 19, 2013

(30) Foreign Application Priority Data
Sep. 17, 2013 (TW) 102133737

(51) Int. Cl. G02F 1/1333

(52) U.S. Cl. CPC G02F 1/13336; G02F 1/133308; G02F 2001/133322
USPC 349/58; 29/407.04

(57) ABSTRACT

A display device includes a housing, a display panel mounted in the housing, and at least one aligning unit. The housing includes at least one pair of opposite sidewalls, each sidewall defines at least one light hole corresponding to the light hole defined in the opposite sidewall. Each aligning unit includes an optical fiber and two collimating lenses, one collimating lens is arranged between and aligned with one end of the optical fiber and one light hole, the other collimating lens is arranged between and aligned with the other end of the optical fiber and one other light hole corresponding to the one light hole.

### BACKGROUND

1. Technical Field

The present disclosure relates to a display device and a display wall including a number of the display devices.

2. Description of Related Art

A display wall includes a number of display devices arranged in an array. Yet, a display device may be mislocated or tilted relative to other display device and making a bad display effect.

Therefore, it is desirable to provide a display device, a display wall, and a method for manufacturing the display wall which can overbecome the shortcomings mentioned above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic, front view of a display device according to a first embodiment of the present disclosure.

FIG. 2 is a cross-sectional view taken along II-II line of the display device of

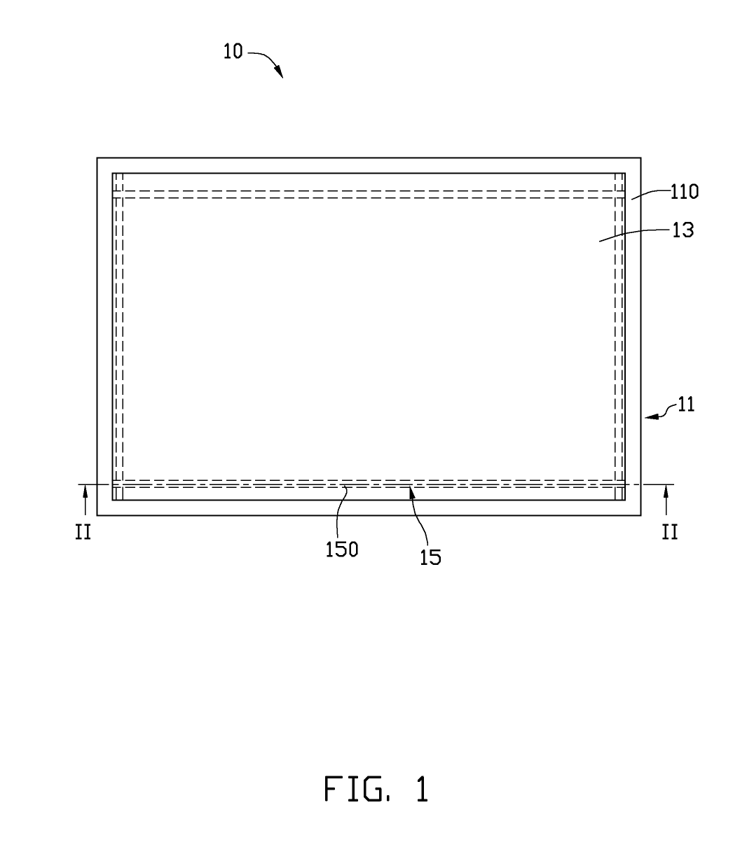

FIG. 1.

FIG. 3 is a schematic, front view of a display wall according to a second embodiment of the present disclosure.

FIG. 4 is a schematic view showing a method for assembling the display wall of FIG. 3.

FIG. 5 is a cross-sectional view taken along V-V line of FIG. 4.

### DETAILED DESCRIPTION

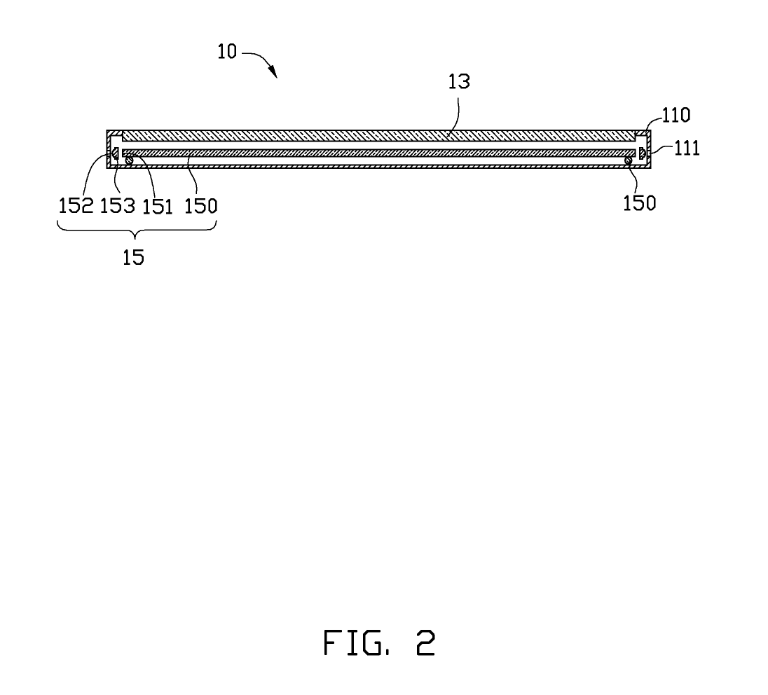

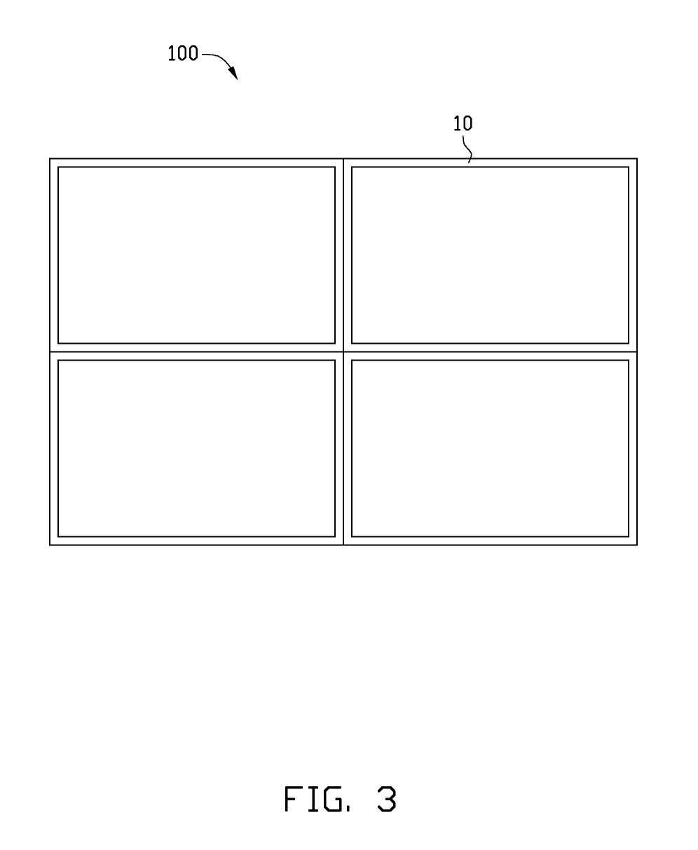

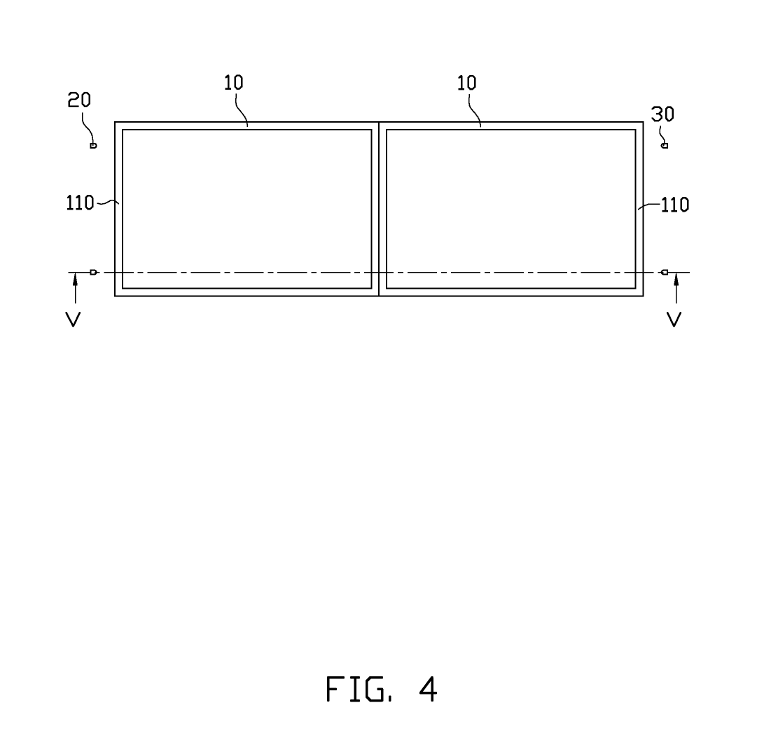

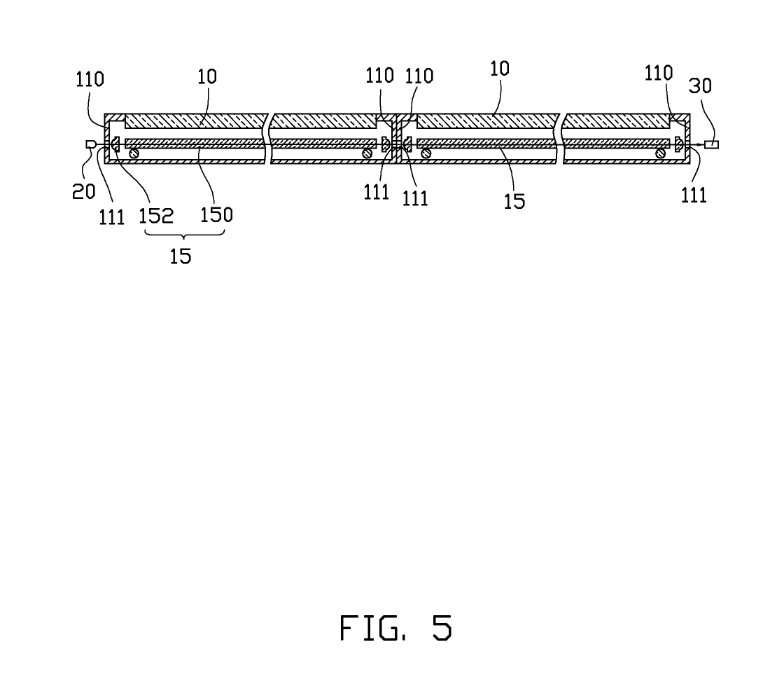

FIGS. 1 and 2 show a display device 10 according to a first embodiment of the present disclosure. In this embodiment, the display device 10 is a liquid crystal display device. In other embodiments, the display device 10 can also be any known type of display device, such as a plasma display device, for example.

The display device 10 includes a housing 11 and a display panel 13 mounted in the housing 11. The housing 11 includes four sidewalls 110 perpendicularly connected end to end. The four sidewalls 110 include two pair of sidewalls. Each pair of sidewalls 110 includes two opposite sidewalls identical to each other in size and are parallel to each other. The sidewalls 110 surround the display panel 13 and have small widths. In this embodiment, the width of the sidewall 110 is smaller than 5 millimeters.

The display device 10 further includes aligning units 15 received in the housing 11. In this embodiment, there are four aligning units 15. Each two aligning units 15 correspond to a pair of sidewalls 110. Each aligning unit 15 includes an optical fiber 150 and two collimating lenses 152 aligned with two ends 151 of the optical fiber 150. Each collimating lens 152 is formed on a substrate 153. In this embodiment, the collimating lens 152 is a convex lens. The collimating lens 152 and the substrate are transparent. The four sidewalls 110 define eight light holes 111. The eight light holes 111 include four pair of light holes. Each pair of light holes 111 corresponds to one aligning unit 15 and is defined in the corresponding pair of sidewalls 110. Each sidewall 110 defines two light holes 111 adjacent to two ends of the sidewall 110. A location of the light hole 111 in one sidewall 110 corresponds to a location of the light hole 111 in the opposite sidewall 110. The collimating lens 152 is arranged between the end 151 of the optical fiber 150 and the corresponding light hole 111 and is aligned with the light hole 111.

FIG. 3 shows a display wall 100 according to a second embodiment of the present disclosure. The display wall 100 includes a number of display device 10 arranged in an array.

FIGS. 4 and 5 show a method for assembling the display wall 100. First, two display devices 10 are assembled together and are roughly aligned with each other. Then two light sources 20 are aligned with two light holes 111 in the sidewall 110 of one display device 10 opposite to the other display device 10, and two photo sensors 30 are aligned with two light holes 111 in the sidewall 110 of the other display device 10 opposite to the one display device 10. In this embodiment, the light sources 20 are laser sources. Light emitted by the light sources 20 transmits through the light holes 111, the collimating lenses 152, the optical fibers 150, and are received by the photo sensors 30. Finally, a location of the other display 10 relative to the one display 10 is adjusted until a light intensity detected by the photo sensors 30 becomes a biggest value. In this way, the two display devices 10 are precisely aligned with each other. Then the above mentioned steps can be repeated until all of the display devices 10 are assembled together.

In detail, the step of adjusting location of the other display 10 relative to the one display 10 until a light intensity detected by the photo sensors 30 becomes a biggest value includes the following sub-steps.

The one display device 10 is fixed, and a location of the other display device 10 along a direction parallel to the two adjacent sidewalls 10 of the two display devices 10 is adjusted until a light intensity detected by one photo sensor 30 becomes a biggest value. In this way, a mislocation of the other display device 10 relative to the one display device 10 is eliminated or at least reduced. Then the one display device 10 and one end of the other display device 10 adjacent to the one photo sensor 30 are fixed, and a location of the other end of the other display device 10 is adjusted until a light intensity detected by the other photo sensor 30 becomes a biggest value. In this way, a tilt of the other display device 10 relative to the one display device 10 is eliminated or at least reduced.

The display devices are precisely aligned by using the aligning units, in this way, a display effect of the display wall is improved.

It will be understood that the above particular embodiments are shown and described by way of illustration only. The principles and the features of the present disclosure may be employed in various and numerous embodiments thereof without departing from the scope of the disclosure. The above-described embodiments illustrate the scope of the disclosure but do not restrict the scope of the disclosure.

What is claimed is:

1. A display device comprising:
a housing comprising at least one pair of opposite sidewalls, each sidewall defining at least one light hole corresponding to the light hole defined in the opposite sidewall;
a display panel mounted in the housing; and
at least one aligning unit, each aligning unit comprising an optical fiber and two collimating lenses, one collimating lens being arranged between and aligned with one end of the optical fiber and one light hole, the other collimating lens being arranged between and aligned with the other end of the optical fiber and one other light hole corresponding to the one light hole.

2. The display device of claim 1, wherein the at least one pair of opposite sidewalls comprises two pair of opposite sidewalls, one of the two pair of opposite sidewalls are connected to the other one of the two pair of opposite sidewalls.

3. The display device of claim 2, wherein in each sidewall, the at least one light hole comprises two light holes adjacent to two ends of the sidewall.

4. The display device of claim 1, wherein in each pair of opposite sidewalls, a size of one sidewall is identical to a size of the other sidewall.

5. A display wall comprising:
a plurality of display devices arranged in an array, each display device comprising:
a housing comprising at least one pair of opposite sidewalls, each sidewall defining at least one light hole corresponding to the light hole defined in the opposite sidewall;
a display panel mounted in the housing; and
at least one aligning unit, each aligning unit comprising an optical fiber and two collimating lenses, one collimating lens being arranged between and aligned with one end of the optical fiber and one light hole, the other collimating lens being arranged between and aligned with the other end of the optical fiber and one other light hole corresponding to the one light hole; wherein
the light holes in adjacent sidewalls of two adjacent the display devices are aligned with each other.

6. The display wall of claim 5, wherein in each display device, the at least one pair of opposite sidewalls comprises two pair of opposite sidewalls, one of the two pair of opposite sidewalls are connected to the other one of the two pair of opposite sidewalls.

7. The display wall of claim 6, wherein in each side wall, the at least one light hole comprises two light holes adjacent to two ends of the sidewall.

8. The display wall of claim 5, wherein in each pair of opposite sidewalls, a size of one sidewall is identical to a size of the other sidewall.

9. A method for manufacturing a display wall, comprising:
providing a plurality of display devices as claimed in claim 1;
assembling two of the plurality of display devices together;
aligning at least one light source with at least one of the light hole defined in the sidewall of one of the two display device opposite to the other one of the two display device, and aligning at least one photo sensor with at least one of the light hole defined in the sidewall of the other one of the two display device opposite to the one of the two display device;
adjusting location of the other one of the two display device relative to the one of the two display device until a light intensity detected by the at least one photo sensor becomes a biggest value; and
repeating the step of assembling two of the plurality of display devices together to the step of adjusting location of the other one of the two display device relative to the one of the two display device until all the plurality of display devices are assembled together.

10. The method of claim 9, wherein in each display device, the at least one pair of opposite sidewalls comprises two pair of opposite sidewalls, one of the two pair of opposite sidewalls are connected to the other one of the two pair of opposite sidewalls;
and wherein in each side wall, the at least one light hole comprises two light holes adjacent to two ends of the sidewall.

11. The method of claim 10, wherein the at least one light source comprises two light sources aligned with two light holes defined in the sidewall of one of the two display device opposite to the other one of the two display device, and the at least one photo sensor comprises two photo sensors aligned with two light hole defined in the sidewall of the other one of the two display device opposite to the one of the two display device.

12. The method of claim 11, wherein adjusting location of the other one of the two display device relative to the one of the two display device until a light intensity detected by the at least one photo sensor becomes a biggest value comprises: fixing the one of the two display devices, adjusting a location of the other one of the two display devices along a direction parallel to the two adjacent sidewalls of the two display devices until a light intensity detected by one of the two photo sensors becomes a biggest value; and fixing the one of the two display devices and one end of the other one of the two display devices adjacent to the one of the two photo sensors, and adjusting a location of an other end of the other one of the two display devices until a light intensity detected by the other one of the two photo sensors becomes a biggest value.

13. The method of claim 9, wherein the at least one light source is a laser source.
